(19) United States
(12) Patent Application Publication
(10) Pub. No.: US 2024/0194217 A1
(43) Pub. Date: Jun. 13, 2024

(54) DATA PROCESSING METHOD FOR ACOUSTIC EVENT

(71) Applicant: INDUSTRIAL TECHNOLOGY RESEARCH INSTITUTE, Hsinchu (TW)

(72) Inventors: Chih-Cheng LU, Hsinchu City (TW); Jian-Bai LI, Chiayi City (TW); Cheng-Ming SHIH, Zhubei City (TW); Yu-Lee YEH, New Taipei City (TW); Kai-Cheung JUANG, Hsinchu City (TW)

(73) Assignee: INDUSTRIAL TECHNOLOGY RESEARCH INSTITUTE, Hsinchu (TW)

(21) Appl. No.: 18/089,189

(22) Filed: Dec. 27, 2022

(30) Foreign Application Priority Data
Nov. 29, 2022 (TW) 111145534

(51) Int. Cl. G10L 25/18

(52) U.S. Cl. CPC G10L 25/18; G10L 2025/937

(57) ABSTRACT

A data processing method for acoustic event includes: establishing a simulated acoustic frequency event module, a data capturing module, and a sound application decision module in a software manner, setting a simulated hardware parameter to the simulated acoustic frequency event module, inputting a sound signal to a frequency filtering module of the simulated acoustic frequency event module, and obtaining metadata from a frequency event quantizer of the simulated acoustic frequency event module, dividing each of the metadata into multiple frames according to a time interval by the data capturing module, accumulating an event number of each frame by the data capturing module, setting a label of each frame according to the event number, storing these frames, the event number and the label in a database, and training a decision model by the sound application decision module according to the database and a sound application.

### CROSS-REFERENCE TO RELATED APPLICATIONS

This non-provisional application claims priority under 35 U.S.C. § 119(a) on Patent Application No(s). 111145534 filed in Taiwan, ROC on Nov. 29, 2022, the entire contents of which are hereby incorporated by reference.

### BACKGROUND

### 1. Technical Field

This disclosure relates to the in-sensor computing, and more particular to a data processing method for acoustic event.

### 2. Related Art

In the conventional architecture of acoustic processing, the sensor includes components such as a microphone, a programmable gain amplifier (PGA), and an analog-to-digital converter (ADC).

However, the amount of output data of the sensor is large, which makes the subsequent extraction of acoustic event features complicated, and the overall operation consumes a lot of power. In addition, it is difficult to change parameter settings in conventional architectures according to application scenarios.

### SUMMARY

In view of the above, the present disclosure proposes a data processing method for acoustic event, which is suitable to various application such as voice activity detection (VAD), voice event detection, vibration monitoring, and audio position detection. The method proposed in the present disclosure may simplify the acoustic and auditory system. The proposed method adopts an analog-digital hybrid computing architecture, realizes ultra-low power consumption and real-time voice feature extraction, and provides artificial intelligence voice application developers with a design of the system power consumption optimization.

According to an embodiment of the present disclosure, a data processing method for acoustic event comprises performing a plurality of steps by a processor, wherein the plurality of steps comprises: establishing a simulated acoustic frequency event module, a data capturing module, and a sound application decision module in a software manner, wherein the simulated acoustic frequency event module comprises: a plurality of frequency band filter modules, a plurality of energy estimation modules connecting to the plurality of frequency band filter modules, and a plurality of frequency event quantizers connecting to the plurality of energy estimation modules; setting at least one of the plurality of frequency band filter modules, the plurality of energy estimation modules and the plurality of frequency event quantizers according to a simulated hardware parameter; inputting a sound signal to the plurality of frequency band filter modules and obtaining a plurality of metadata from the plurality of frequency event quantizers, wherein the sound signal is an analog electric signal and the plurality of metadata is digital signals; dividing each of the plurality of metadata into a plurality of frames according to a time interval by the data capturing module, wherein each of the plurality of frames has a timestamp; accumulating an event number of each of the plurality of frames by the data capturing module, setting a label of each of the plurality of frames according to the event number, and storing the plurality of frames, the event number and the label in a database, and training a decision model by the sound application decision module according to the database and a sound application.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a flowchart of the data processing method for acoustic event according to an embodiment of the present disclosure; and

FIG. 2 is an architectural diagram of the processing system of acoustic event according to an embodiment of the present disclosure.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present invention. The following embodiments further illustrate various aspects of the present invention, but are not meant to limit the scope of the present invention.

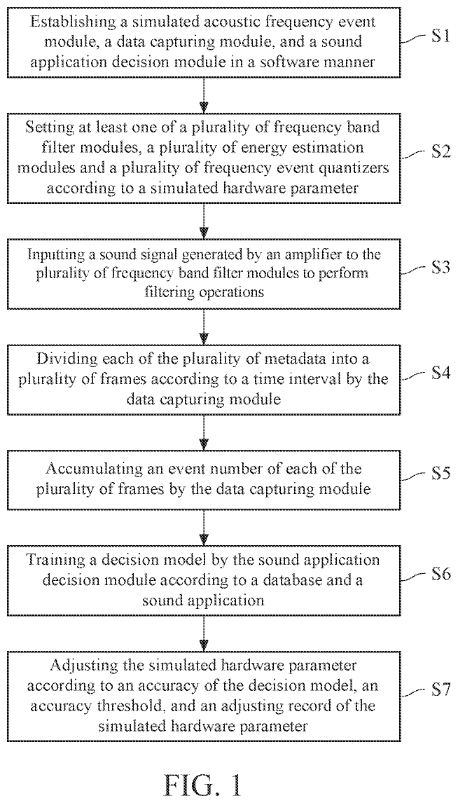

FIG. 1 is a flowchart of the data processing method for acoustic event according to an embodiment of the present disclosure and includes steps S1-S6.

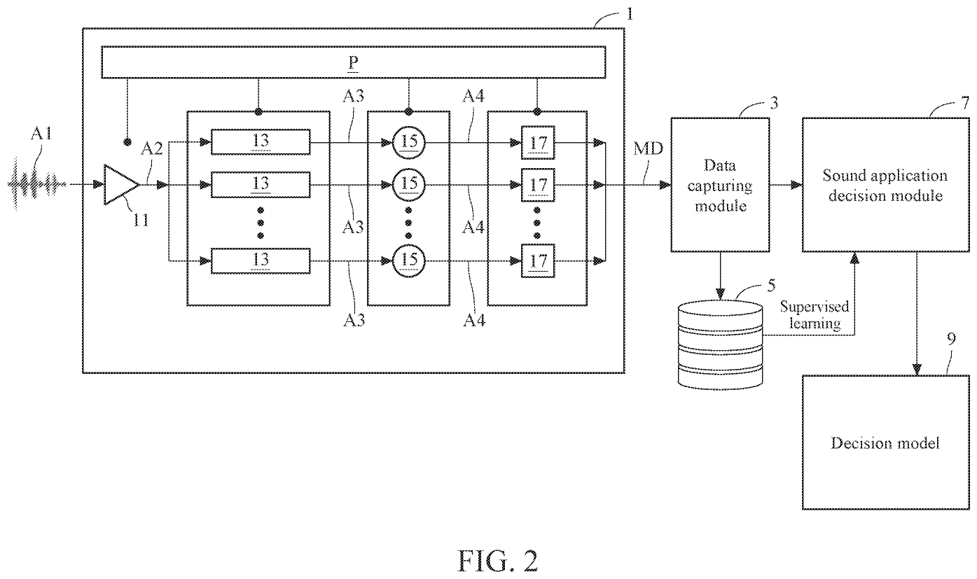

In step S1, a simulated acoustic frequency event module, a data capturing module, and a sound application decision module are established in a software manner, and these modules form a processing system of acoustic event. FIG. 2 is an architectural diagram of the processing system of acoustic event according to an embodiment of the present disclosure. As shown in FIG. 2, the simulated acoustic frequency event module includes an amplifier 11, a plurality of frequency band filter modules 13, a plurality of energy estimation modules 15, and a plurality of frequency event quantizers 17. The amplifier 11 receives an external audio stream A1 and converts it into a sound signal A2. The sound signal A2 is an analog electric signal. As shown in FIG. 2, the amplifier 11 is coupled to the plurality of frequency band filter modules 13. Each of the plurality of frequency band filter modules 13 is coupled to one of the plurality of energy estimation modules 15. Each of the plurality of energy estimation modules 15 is coupled to one of the plurality of frequency event quantizers 17. In an embodiment, an output signal A3 of the plurality of frequency band filter modules 13 and an output signal A4 of the plurality of energy estimation modules 15 are one of voltage, current, and charge.

In step S2, at least one of the plurality of frequency band filter modules 13, the plurality of energy estimation modules 15 and the plurality of frequency event quantizers 17 is (are) set according to a simulated hardware parameter P.

Since the system shown in FIG. 2 is implemented in software, corresponding simulation hardware parameters P can be set for the plurality of frequency band filter modules 13, the plurality of energy estimation modules 15 and the plurality of frequency event quantizers 17 respectively, thereby simulating the input and output operations when the aforementioned modules are implemented in hardware. In an embodiment, the amplifier 11, the plurality of frequency band filter modules 13, the plurality of energy estimation modules 15 and the plurality of frequency event quantizers 17 may be integrated in an acoustic sensor in terms of hardware implementation, so as to realize the purpose of in-sensor computing. In another embodiment, the amplifier 11 may be omitted, or the amplifier 11 may be disposed outside the sensor, so that the sensor can directly receive the sound signal A2 generated by the amplifier 11 and then perform the in-sensor computing. The present disclosure does not limit the installation position of the amplifier 11.

In an embodiment, the simulated hardware parameter P is configured to be assigned to the plurality of frequency band filter modules 13, and the simulated hardware parameter P includes a filter gain, a frequency lower limit, a frequency upper limit, a filter bandwidth, a combination of central frequency, a filter method, a filter order, and the number of channels, and the number of the plurality of frequency band filter modules 13 is equal to the number of channels. The following Table 1 is a setting example of the simulated hardware parameter P for the plurality of frequency band filter modules 13, and the applicable sound application is human voice discrimination. In the example of Table 1, the human voice application frequency band is 50 Hz to 5000 Hz, and the central frequency setting includes log values that are evenly distributed, so the selected frequency set may be: [100, 129, 168, 218, 283, 368, 478, 620, 805, 1045, 1357, 1760, 2286, 2967, 3852, 5000].

TABLE 1
the setting example of the simulated hardware parameter
for the plurality of frequency band filter modules.
Sound application: voice discrimination
Simulated hardware parameters

| Name | Setting | |
|---|---|---|
| Frequency lower limit | 100 | Hz |
| Frequency upper limit | 5000 | Hz |
| Number of channels | 16 | Channels |

| | |
|---|---|
| Filter method | Band pass filter, |
| | High and low pass filter, |
| | Custom function filter |
| Central frequency | Log values that are evenly |
| | distributed |
| Filter order | 2 |

In an embodiment, the simulated hardware parameter P is configured to be assigned to the plurality of energy estimation modules 15, and the simulated hardware parameter P includes an energy gain, an energy threshold, and the number of channels, the number of the plurality of energy estimation modules 15 is equal to the number of channels, and the plurality of energy estimation modules 15 are implemented by the waveform rectifier(s).

In an embodiment, the simulated hardware parameter P is configured to be assigned to the plurality of frequency event quantizers 17, and the simulated hardware parameter P comprises a bit width, a data dynamic range, a time resolution, a time interval and the number of channels, the number of the plurality of frequency event quantizers 17 is equal to the number of channels. The plurality of frequency event quantizers 17 are configured to output a first value (such as 1) representing that an event occurs when an energy of an input signal (the output signal A4 of the energy estimation module 15) is greater than a threshold, and output a second value (such as 0) representing that the event does not occur when the energy of the input signal (the output signal A4 of the energy estimation module 15) is smaller than the threshold. The following Table 2 is a setting example of the simulated hardware parameter P for the plurality of frequency event quantizers 17.

TABLE 2
the setting example of the simulated hardware parameter
P for the plurality of frequency event quantizers 17.
Simulated hardware parameters

| Name | Setting |
|---|---|
| Energy threshold (after | 0.02 |
| filtering | |
| Bit width | 8 bits/16 bits |
| Data dynamic range | 0~450 |
| Time frame limit | Yes/No |
| Time resolution | 25 milliseconds |
| Time frame | 10 milliseconds |

In Table 2, when the setting of time frame is “Yes”, the plurality of frequency event quantizers 17 may output the number of event signals according to the time frame and the frame length. When the setting of time frame is “No”, the plurality of frequency event quantizers 17 may output the determination about whether a frequency event occurs or not according to the sound sampling rate.

In step S3, the sound signal A2 generated by the amplifier 11 is inputted to the plurality of frequency band filter modules 13 for performing the filtering operation. In an embodiment of step S3, before inputting the sound signal A2 to the plurality of frequency band filter modules 13, the proposed method further includes: establishing the amplifier 11 in software manner, and inputting an audio stream to the amplifier 11 to generate the sound signal A2. In another embodiment of step S3, the sound signal A2 may be obtained from the external amplifier and inputted to the plurality of frequency band filter modules 13. In another perspective, the present disclosure does not limit whether to implement the amplifier 11 in software manner and inside the sensor. In practice, the amplifier 11 may be implemented inside or outside the sensor according to the requirement.

Please refer to FIG. 2 and step S3, each of the plurality of frequency band filter modules 13 corresponds to a channel, each of the plurality of frequency band filter modules 13 is coupled to one of the plurality of energy estimation modules 15 for sending signals. The plurality of energy estimation modules 15 implement the function of waveform rectifier. Each of the plurality of energy estimation modules 15 is coupled to one of plurality of frequency event quantizers 17.

In an embodiment, each of the plurality of energy estimation modules 15 takes the absolute value of the output signal A3 of the corresponding frequency band filter module 13 and outputs it to the corresponding frequency event quantizer 17. The frequency event quantizer 17 performs a threshold determination according to the result after taking the absolute value, and outputs the result higher than the threshold as the output signal. In this way, it is possible to prevent signals with relatively low energy from disturbing subsequent determinations. Accordingly, the frequency event quantizer 17 determines whether the energy of the input signal (the output signal A4 of the energy estimation module 15) exceeds the threshold. If the determination is “Yes”, the input signal (the output signal A4 of the energy estimation module 15) is determined as having one event occurrence. As the sound signal A2 is continuously inputted to the frequency band filter modules 13, the frequency event quantizers 17 will also output a signal to represent whether an event occurs at each moment along with time.

The output MD of the frequency event quantizer 17 is called “metadata” in the present disclosure. Since the sound signal A2 has been filtered by the plurality of frequency band filter modules 13 of different frequency bands, the size of the metadata MD is much smaller than the output signal of the ADC in the conventional architecture. Because the size of the metadata MD is small, the subsequent processing is easier, and the processing power consumption is also reduced accordingly.

In step S3, the audio signal A2 belonging to the analog electrical signal is sequentially processed by the frequency band filter modules 13, the energy estimation module 15, and the frequency event quantizer 17 to output a plurality of metadata MD, and the metadata MD belongs to the digital signal. Each metadata MD corresponds to a channel.

In step S4, the data capturing module 3 divides each metadata MD into a plurality of frames according to a time frame, and each frame has a timestamp.

In an embodiment, the output (metadata MD) of each of the plurality of frequency event quantizers 17 is an asynchronous time series, for example, in the form of 0100010110101 . . . , where 0 represents no event at a certain time point, 1 means that an event occurs at a certain time point. The data capturing module 3 cuts the time series according to a specified time frame (for example, 5 ms), and gives a time stamp to each cut frame.

TABLE 3
an example of the timestamp, the number of events, and the labels.

| Time- | | |
|---|---|---|
| stamp | The number of events E | Label |
| 1 2 3 . . . k | $[ \begin{matrix}{E}_{11} & {E}_{12} & {E}_{13} & … & {E}_{1 ( n - 1 )} & {E}_{1 ( n )} \\ {E}_{21} & {E}_{22} & {E}_{23} & … & {E}_{2 ( n - 1 )} & {E}_{2 ( n )} \\ {E}_{31} & {E}_{32} & {E}_{33} & … & {E}_{3 ( n - 1 )} & {E}_{3 ( n )} \\ . & . & . & … & . & . \\ . & . & . & … & . & . \\ {E}_{k 1} & {E}_{k 2} & {E}_{k 3} & … & {E}_{k ( n - 1 )} & {E}_{k ( n )}\end{matrix} ]$ | Non-speech Non-speech Speech . . . Non-speech |

In step S5, the data capturing module 3 accumulates the number of events in each frame. In an embodiment, there is a counter in the data capturing module 3, which is used to count the number of “1” in the cut frame. The label of each frame is set according to the number of events of all channels. All frames and their event counts and their labels are stored in the database 5. Table 3 above is an example showing the result after the processing of the data capturing module 3, where the timestamps are 1 to k. Each row of the matrix represents a piece of metadata MD. This matrix has n columns, representing that the number of channels is n. This matrix has k rows, representing that a piece of metadata MD is divided into k frames. Each element Eᵢⱼ in the matrix represents the number of events in the frame. The operation of “setting a label” mentioned in step S5 may automatically generate the label in accordance with a specified event threshold through software manner. For example, when the cumulative number of events of all channels exceeds 10, it is labeled as speech, otherwise it is labeled as non-speech. The present disclosure does not limit the determination conditions for setting the label.

The framework of conventional acoustic event processing lacks a database of frequency event metadata. Therefore, in the data processing method for acoustic event according to an embodiment of the present disclosure, a mechanism for labeling acoustic frequency event data is implemented through step S5, which helps the subsequent sound application decision module 7 to have a corresponding database 5 when performing a supervised learning.

In step S6, the sound application decision module 7 performs the trainings according to the database 5 and the sound applications, and thereby establishing a decision model 9. In an embodiment, the sound application includes a voice activity detection (VAD). a keyword spotting, an acoustic environment identification, an acoustic abnormal sound detection and an ultrasonic vibration detection, and the decision model 9 is a fully connected neural network. For example, if the sound application is to detect whether the voice exists or not, the number of neurons in the output layer of the fully connected neural network is 2 (exist/not exist). If the sound application is keyword detection, the output number is the number of keywords. In an embodiment, “performing the training according to the database 5 and the sound application by the sound application decision module 7” refers to the supervised learning.

In step S7, the simulated hardware parameter P is adjusted according to the accuracy of the decision model 9, the accuracy threshold, and the adjusted record of the simulated hardware parameter P. In an embodiment, the adjusting range of the simulated hardware parameter P may be set in advance (For example, the range of the number of channels is 8-128 channels), and a set of parameters within the range is selected to train the decision model during each time of the training, and then the model accuracy is outputted after the training is completed. If the accuracy of the model meets the accuracy threshold set by the user, the simulated hardware parameter P does not need to be adjusted. If the accuracy of the model does not meet the accuracy threshold, another set of simulated hardware parameter P is randomly selected from the selectable range for training. In an embodiment, the value settings of the simulated hardware parameter P are associated with the sound application. For example, if the sound application is keyword detection, the number of channels may be set to 32 or 64, and the time resolution may be set to a higher value; if the sound application is voice activity detection, the number of channels may be set to 16, and it is suitable to set higher values for energy gain and energy threshold to achieve the effect of suppressing some environmental noises.

The operations of the data processing method for acoustic event described in any of the aforementioned embodiments may be implemented by one or more computer-readable instructions, and the computer-readable instructions may be stored in a non-transitory computer readable medium, and a processor may read and execute the operation of the data processing method. The processor is, for example, a central processing unit, a graphics processing unit, and the like.

The following Table 4 is a comparison of the accuracy of the decision model 9 established according to the data processing method for acoustic event according to an embodiment of the present disclosure, where the test data set is a noisy speech corpus (NOIZEUS) with four signal-to-noise ratios (SNR 0-SNR 15). The accuracy of the decision model 9 is calculated by dividing the number of correct predicted frames by the number of all frames. The VAD model uses a fully connected neural network, and two neurons are outputted in the last to represent the speech or non-speech. The parameters of the voice IC include the sampling rate (10000), the number of channels (60), and the threshold (0.005).

TABLE 4
the comparison of the accuracy of the decision model

SNR

| Scenario | SNR 0 | SNR 5 | SNR 10 | SNR 15 |
|---|---|---|---|---|
| Airport | 0.6823 | 0.8281 | 0.8828 | 0.9141 |
| Babble | 0.6797 | 0.8216 | 0.8815 | 0.9167 |
| Car | 0.7318 | 0.8424 | 0.9076 | 0.9102 |
| Exhibition | 0.8516 | 0.8359 | 0.8906 | 0.9089 |
| Restaurant | 0.6927 | 0.8464 | 0.8685 | 0.9036 |
| Station | 0.7409 | 0.8581 | 0.9089 | 0.8971 |
| Street | 0.6992 | 0.8164 | 0.8659 | 0.8776 |
| Train | 0.8372 | 0.8737 | 0.8646 | 0.9036 |

In view of the above, the data processing method for acoustic event proposed by the present disclosure adopts the software-hardware collaborative design, including establishing a simulated hardware behavior framework as a conversion tool to connect with the existing artificial intelligence framework. The method proposed by the present disclosure includes the process of generating and labeling the metadata training data set, which may be used for the development of the application model. In addition, the present disclosure may perform hardware information feedback according to the accuracy defined by the user, thereby improving the accuracy of the application model. The power consumption of the ultra-low power consumption speech feature extraction chip produced by the application of the present disclosure may be less than 1 microwatt (μW). On the other hand, the power consumption using the conventional architecture (usually greater than 100 μW) is a hundred times more than the power consumption applying the present disclosure.

What is claimed is:

1. A data processing method for acoustic event comprising performing a plurality of steps by a processor, wherein the plurality of steps comprises:
establishing a simulated acoustic frequency event module, a data capturing module, and a sound application decision module in a software manner, wherein the simulated acoustic frequency event module comprises: a plurality of frequency band filter modules, a plurality of energy estimation modules connecting to the plurality of frequency band filter modules, and a plurality of frequency event quantizers connecting to the plurality of energy estimation modules;
setting at least one of the plurality of frequency band filter modules, the plurality of energy estimation modules and the plurality of frequency event quantizers according to a simulated hardware parameter;
inputting a sound signal to the plurality of frequency band filter modules and obtaining a plurality of metadata from the plurality of frequency event quantizers, wherein the sound signal is an analog electric signal and the plurality of metadata is digital signals;
dividing each of the plurality of metadata into a plurality of frames according to a time interval by the data capturing module, wherein each of the plurality of frames has a timestamp;
accumulating an event number of each of the plurality of frames by the data capturing module, setting a label of each of the plurality of frames according to the event number, and storing the plurality of frames, the event number and the label in a database; and
training a decision model by the sound application decision module according to the database and a sound application.

2. The data processing method for acoustic event of claim 1, wherein the simulated hardware parameter is configured to be assigned to the plurality of frequency band filter modules, and the simulated hardware parameter comprises a filter gain, a frequency lower limit, a frequency upper limit, a filter bandwidth, a central frequency, a filter method, a filter order, and a number of channels, and a number of the plurality of frequency band filter modules is equal to the number of channels.

3. The data processing method for acoustic event of claim 1, wherein the simulated hardware parameter is configured to be assigned to the plurality of energy estimation modules, and the simulated hardware parameter comprises an energy gain, an energy threshold, and a number of channels, a number of the plurality of energy estimation modules is equal to the number of channels, and the plurality of energy estimation modules are implemented by a waveform rectifier.

4. The data processing method for acoustic event of claim 1, wherein the simulated hardware parameter is configured to be assigned to the plurality of frequency event quantizers, and the simulated hardware parameter comprises a bit width, a data dynamic range, a time resolution, a time interval and a number of channels, a number of the plurality of frequency event quantizers is equal to the number of channels, the plurality of frequency event quantizers are configured to output a first value representing that an event occurs when an energy of an input signal is greater than a threshold, and output a second value representing that the event does not occur when the energy of the input signal is smaller than the threshold.

5. The data processing method for acoustic event of claim 1, before inputting the sound signal to the plurality of band filter modules, further comprising:
establishing an amplifier in the software manner; and
inputting an audio stream into the amplifier to generate the sound signal, wherein an output of the plurality of frequency band filter modules and an output of the plurality of energy estimation modules are one of voltage, current, and charge.

6. The data processing method for acoustic event of claim 1, further comprising adjusting the simulated hardware parameter by the processor according to an accuracy of the decision model, an accuracy threshold, and an adjusted record of the simulated hardware parameter.

7. The data processing method for acoustic event of claim 1, wherein the sound application comprises a voice activity detection, a keyword spotting, an acoustic environment identification, an acoustic abnormal sound detection and an ultrasonic vibration detection, and the decision model is a fully connected neural network, an output number of the decision model is associated with the sound application.

8. The data processing method for acoustic event of claim 1, wherein training the decision model by the sound application decision module according to the database and the sound application is a supervised learning.

9. The data processing method for acoustic event of claim 1, wherein a value setting of the simulated hardware parameter is associated with the sound application.
